(19) United States
(12) Patent Application Publication
(10) Pub. No.: US 2011/0036205 A1
(43) Pub. Date: Feb. 17, 2011

(54) Board removal tool

(75) Inventors: Marc Pafumi, Norman Park (AU); Thomas H. Tranter, Norman Park (AU)

Correspondence Address: HUDAK, SHUNK & FARINE, CO., L.P.A., 2020 FRONT STREET, SUITE 307, CUYAHOGA FALLS, OH, 44221, US

(73) Assignee: EZY LIFTER PTY, LTD., NORMAN PARK (AU)

(21) Appl. No.: 12/800,761

(22) Filed: May 21, 2010

(30) Foreign Application Priority Data
Aug. 11, 2009 (AU) 2009100791

(51) Int. Cl. B25B 27/14; B66F 15/00

(52) U.S. Cl. 81/46; 29/426.5

(57) ABSTRACT

A board removal tool (10), for the removal of boards (or panels) (F) from building structures (FS) such as floors, walls or ceilings, has an elongate handle (20), connected a tool body (30) having aligned, spaced first and second jaw members (40, 50) at one end; the first and second jaw members (40, 50) having opposed jaw faces (41, 51) to receive the boards (F) therebetween. The handle (20) has a hand-grip (23) at the other end, which is rearwardly inclined. The workman engages several boards (F) between the first and second jaw members (40, 50), with the opposed jaw faces (41, 51) extending transverse to the boards (F); and pulls the hand-grip (23) to move the hand-grip (23) in a curved path towards himself. As the tool (10) “rotates” about a distal end (53) of the second jaw member (50), the first jaw member (40) progressively removes/releases at least some of the boards (F) from the building structure(FS) to which the boards (F) were fixed.

### BACKGROUND OF THE INVENTION

1. Field of the Invention

THIS INVENTION relates to a board removal tool.

The invention particularly relates, but is not limited to, a tool suitable for the removal of floorboards of flooring systems, including those having concealed fixing of the floorboards to the supporting floor structure (e.g., joists), including such fixing by fixing members such as decking clips or “biscuits” (or other fixing members).

Throughout the specification, the term “flooring system” shall be used to include flooring systems, wall systems (e.g., wall cladding), ceiling systems and other building construction systems. Such systems may be provided in domestic or commercial building structures, and in associated structures, such as decks, verandahs and the like.

Throughout the specification, the terms “board” and “floorboard” shall include floorboards, decking boards, wall boards and ceiling boards, or the like; and equivalent building panels.

2. Prior Art

Until fairly recently, the floorboards in flooring systems were typically secured to the supporting floor joists (or bearers) by nails, screws or other like fasteners. These flooring systems had a number of limitations, especially when the outer surfaces of the floorboards were to be left exposed (i.e., coated with a protective finish) and not covered by carpet(s), rug(s), vinyl sheeting, ceramic or vinyl tiles, or similar floor coverings.

Various floorboard systems have been produced where the floorboards have complementary interlocking profiles along respective side walls of the floorboards. Typically, one side wall of each floorboard has a projection (or tongue) engageable in a complementary recess or groove in the other side wall of the similar floorboard, when the two floorboards are placed together. In some examples of these systems, the projections may be releasably lockable within the recesses or grooves, the projections typically having hook-like profiles in end view.

Further types of flooring system which has been adopted using different types of fixing members, such as (decking) clips or “biscuits”, which are placed at (usually regular) spacings along the floor joists, engageable in the recesses or grooves, having parallel sides, provided along the side walls of the floorboards. Typically, with these flooring systems, the first floorboard is laid on the floor joist; a set of clips or biscuits are engaged with the recess or groove of the first floorboard; the clips or biscuits are fixed to the respective floor joists; a second floorboard is placed in position, with one side wall engaged with the first set of clips or biscuits; and is then secured along its other side wall by a second set of the clips or biscuits fixed to the respective floor joists.

With all these flooring systems, there have been problems in maintaining the floorboards in the required side-by-side relationship as the floorboards are fixed to the floor joists, by whichever fixing method is used; and to overcome any “warping” of the floorboards, to ensure the floorboards are fixed to the floor joists in secure (i.e., non-rattling) connection; as any system which is subject to “rattling” or “drumming” of the floorboards as the floor is traversed, is unacceptable to the market place. The secure connection of the floorboards to the supporting floor joists must also be able to withstand the expansion and contraction of the floorboards, due to differences in temperature and/or (more particularly) humidity in the building locations, where they are installed.

The secure fixing of the floorboards to the floor joists and/or bearers (or equivalents, such as wall studs for wall boards/panels) causes difficulties to renovators and/r demolishers when the floorboards are to be removed.

These difficulties are multiplied when the floorboards are to be recovered for restoration, recycling or re-use.

When releasing the floorboards from the supporting floor joists, the workman (workmen) typically has to release each floorboard from each floor joist to which it is fixed, using a hammer-and-chisel or a demolisher's tool (commonly-called a “jemmy-bar” or “breaker-bar”). Having released one floorboard, the method must be repeated for the next floorboard, and then for the next.

As the floorboards may be several metres long, the workman follows a “zig-zag” like path across the floor as each board is released from one end to the other.

In addition, the workman must bend- or kneel-down to use the tool(s) to release the floorboards.

### SUMMARY OF THE PRESENT INVENTION

It is an object of the present invention to provide a tool operable (or configured) for the removal, or release, of a plurality of boards (as hereinbefore defined) from the support structure(s) of flooring systems (also as hereinbefore defined)

It is a preferred object of the present invention to provide such a tool which is operable to simultaneously remove, or release, the, or each, board from a number of floor joists or other supporting structures.

It is a further preferred object to provide such a tool which is operable to minimize damage to the face(s) of the boards, as they are removed, or released, so that the boards may be recycled or re-used.

It is a still further preferred object to provide a tool which is relatively light but robust; is relatively inexpensive to manufacture; and easy to use.

It is a still further preferred object to provide a tool with high-standard OH&S features; and which is ergonomically well-designed.

Other preferred objects will become apparent from the following description.

In one aspect, the present invention resides in a board removal tool for a flooring system (as hereinbefore defined) including:

an elongate handle member;

a first jaw member at, or adjacent, one end of the handle member;

a second jaw member on the handle member, substantially aligned with but spaced from the first jaw member; and

the first and second jaw members extend substantially laterally from one side of the handle member and are provided with opposed first and second jaw faces operable to engage opposed faces of the boards of the flooring system and to remove, or release, the boards from support members (or floor joists) of the flooring system when the other end of the handle member is moved along a substantially curved, or arcuate, path in a plane on the one side of the handle member, substantially aligned with the first and second jaw members.

Preferably, the first and second jaw members are spaced so that the distance between the opposed first and second jaw faces is in the range of 2-6 times of the thickness of the boards (i.e. the distance between the opposed faces of the boards). More preferably, the distance is in the range of 3-4 times of the thickness.

Preferably, the lengths of the opposed first and second jaw faces are at least 3 times the width of the boards, so that at least 2 boards will be removed, or released, from the adjacent floor joists each time the tool is used.

Preferably, the opposed first and second jaw faces are inwardly convergent; may be provided with (preferably) tough plastics- or rubber-linings or inserts to protect the opposed faces of the boards against damage; and/or may be provided, at or adjacent their inner ends, with inwardly-directed “teeth-like” ribs or like formations to provide non-slip engagement between the opposed first and second jaw faces and the respective opposed faces of the board(s) engaged thereby.

Preferably, a hand-grip is provided at the other end of the handle member; the longitudinal axis of the hand-grip preferably being inclined relative to the longitudinal axis of the handle member in a direction opposite to the opposite side of the handle member.

In a second aspect, the present invention resides in a method of removal, or release, of a plurality of boards from a flooring system (as hereinbefore defined), employing the board removal tool hereinbefore described, including the steps of:

locating the opposed first and second jaw faces with the opposed faces of the boards there-between, the first and second jaw members extending substantially transverse to the longitudinal axes of the boards; and

moving the other end of the handle member in a substantially curved, or arcuate, path in a plane on the one side of the handle member, substantially aligned with the first and second jaw members.

Preferably, the handle member is moved by an operator pulling the other end of the handle member, or the hand-grip, towards himself, preferably with two hands.

### BRIEF DESCRIPTION OF THE DRAWINGS

To enable the invention to be fully understood, preferred embodiments will now be described with reference to the accompanying drawings, in which:

FIG. 1 is a side elevational view of a board removal tool in accordance with the present invention;

FIG. 2 is a front isometric view thereof;

FIG. 3 is a rear isometric view thereof;

FIGS. 4 to 8 are respective side elevational views showing respective steps of the use of the board removal tool in the method of removing (or releasing) floorboards from the (supporting joists) of a floor or deck.

### DETAILED DESCRIPTION OF THE PREFERRED EMBODIMENTS

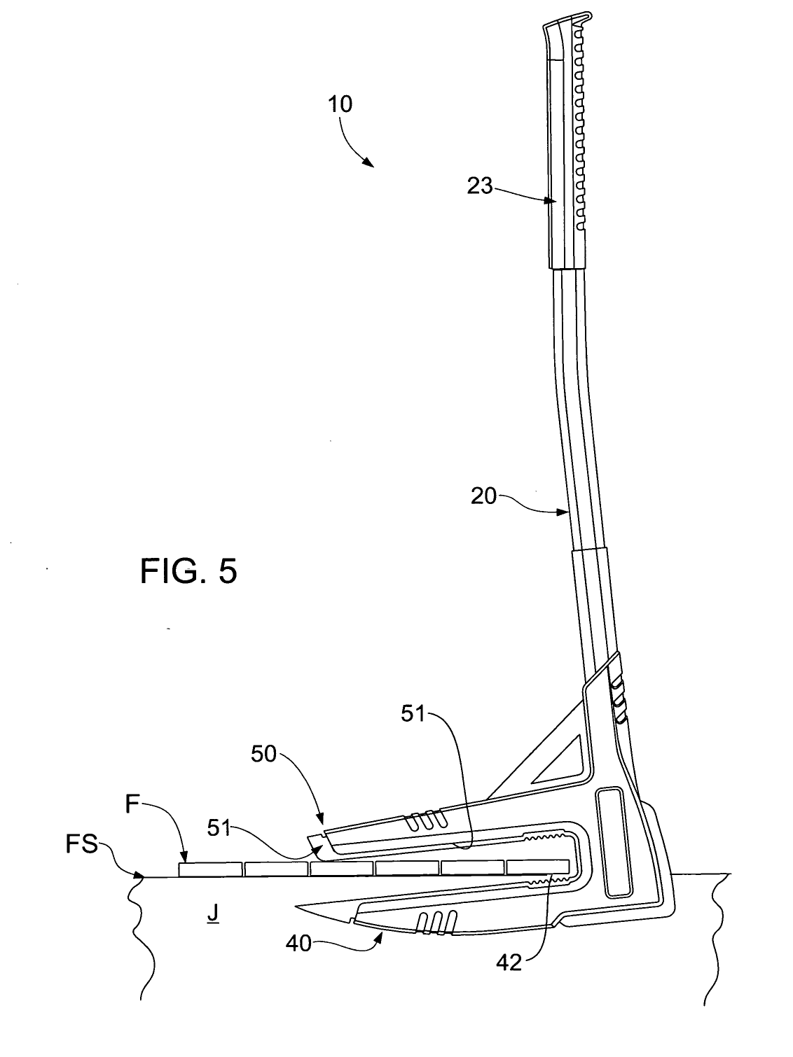

The board removal tool 10 is operable to enable the removal of two or more floorboards F fixed to the supporting floor joists J of a flooring system FS—see FIG. 5.

The floorboards F may be fixed to the floor joists J by fixing members including nails, screws, clips (e.g., decking clips), “biscuits” or the like (not shown).

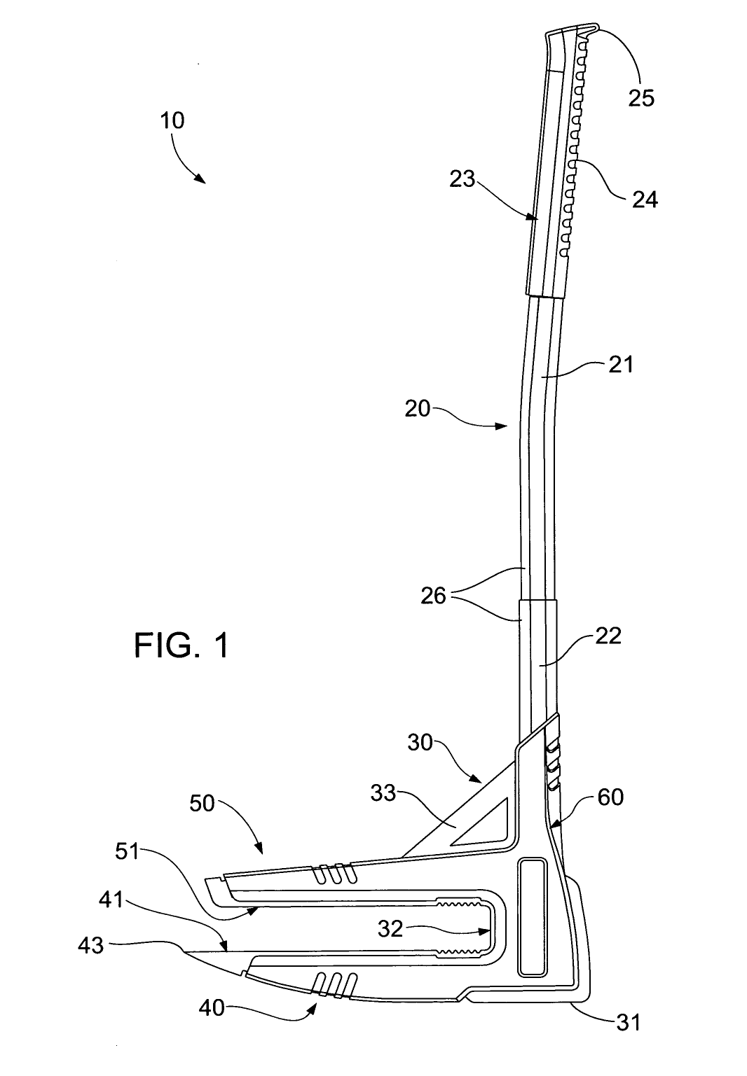

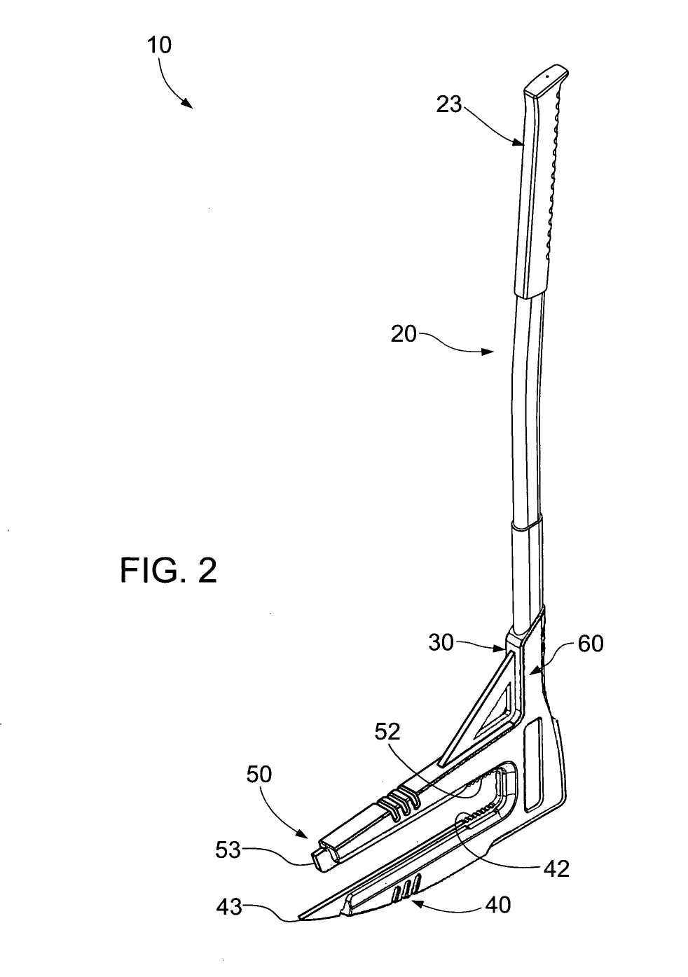

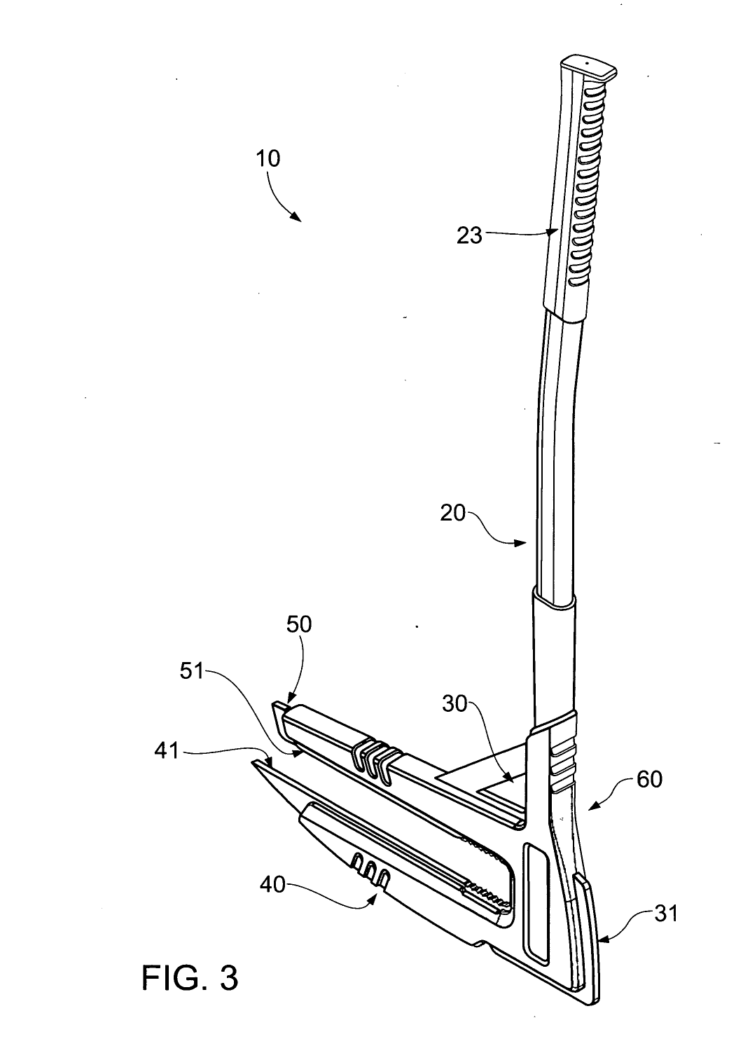

In the embodiment of the tool 10 to be hereinafter described with reference to FIGS. 1 to 8, the tool 10 is designed to be used for the removal of “hardwood” flooring boards F from the flooring joists J. A modified embodiment, not illustrated, will be described to enable the tool 10 to be used to remove “softwood” (e.g., pine) floorboards F without damage to the faces thereof.

The tool 10 has an elongate handle 20, preferably formed of metal (e.g., steel or aluminium), or suitable plastics material (e.g., HDPE or PVC), which may be glass- or fibre-reinforced. The upper portion 21 of the handle 20 has its longitudinal axis “rearwardly inclined” relative to the longitudinal axis of the lower portion 22 of the handle 20. The upper portion 21 of the handle 20 is provided with an elongate hand-grip 23, preferably moulded or extruded from “softer” elastomeric material (e.g., plastics or rubber). Preferably, the hand-grip 23 is designed to be gripped by both of the workman's hands and additional safety is provided by ribbed projections 24 and an end stop 25.

In the embodiment illustrated in FIGS. 1 to 8, the handle 20 is surrounded by a plurality of tubular sections 26, preferably formed of “foam” or “low-density” rubber or plastics, to protect the handle 20 against wear and damage, and to provide a “soft-grip” for the tool 10 when being carried from location to location.

The tool 10 has a tool body 30 connected to the handle 20, the tool body 30 being optionally manufactured from “tough”/“durable” materials, such as tool-steel, aluminium or plastics-material (which may be fibre-reinforced). When the tool body 30 is manufactured from, e.g., aluminium or plastics-material, a tool-steel “heel” 31, of substantially L-shape may be provided at the rear of the tool body 30 to enable the tool 10 to be used in the manner of a long-handled hammer.

First and second jaw members 40, 50 (in the embodiment illustrated, the respective lower and upper jaw members) are formed integrally with, or detachably mounted on, the tool body 30 and extend laterally to one side of the handle 20. The first and second jaw members 40, 50 are aligned and are provided with opposed first and second jaw faces 41, 51, which are inwardly convergent towards an inner face 32 (defined by the tool body 30). Teeth-like projections 42, 52 interconnect the opposed first and second jaw faces 41, 51 with the inner face 32, to provide improved engagement between the jaw faces 41, 51 and the floorboards F, as will be hereinafter described.

An inclined reinforcing bracket 33 interconnects the second jaw member 50 with the tool body 30 (or the handle 20), to reinforce the second jaw member 50 and to maintain its angular location relative to the handle 20, when the tool 10 is in use, as will be hereinafter described.

The distal end 43 of the first jaw member 40 tapers to a point, which may be used as a “digging-point” or “separating point”, e.g., to remove the floorboard(s) F adjacent a wall or other fixed obstruction; while the distal end 53 of the second jaw member 50 has an inclined, planar face, which both provides a “lead into” space formed between the opposed jaw faces 41, 51, and can also act as a hammer face.

In the embodiment illustrated, a protective cover 60, e.g., moulded from plastics- or rubber-material (preferably in a “high-visibility” colour) is provided about the majority of the tool body 30 and of the first and second jaw members 40, 50 to protect them against unwanted damage, e.g., when the tool 10 is in transport.

In the embodiment illustrated in FIGS. 1 to 8, the first and second jaw members 40, 50 have respective lengths of approximately four times the width of the “hardwood” floorboards F; while the distance between the opposed first and second jaw faces 41, 51 is approximately three to four times the thickness of the “hardwood” floorboards F.

The skilled addressee will appreciate that the lengths of the jaw members 40, 50 and/or and the distance between the first and second jaw faces 41, 51 can be varied to suit floorboards F of different widths and/or thicknesses, and/or the number of floorboards F to be removed or released from the joists J each time the tool is used.

For “softwood” (e.g., pine) floorboards F, respective inserts (not illustrated), preferably made of tough plastics- or rubber-material (e.g., which may be fibre-reinforced) can be fitted to the first and second jaw members 40, 50 to overlie the first and second jaw faces 41, 51 (to provide secondary jaw faces with a reduced distance there-between). The distance between the secondary jaw faces may be in the range 2-3 times the thickness of the “softwood” floorboards F.

Respective inserts may be provided for the first and second jaw members 40, 50; or a single insert may be provided; where the location and/or restraint of the insert(s) is assisted by the teeth-like projections 42, 52 adjacent the inner face 32.

Preferably, the length of the handle 20 is selected such that a workman can grip the hand-grip 23 with both hands at a height between shoulder and waist high, where such a length provides sufficient leverage to enable the floorboards F to be removed from the floor joists J without the workman having to apply excessive physical effort.

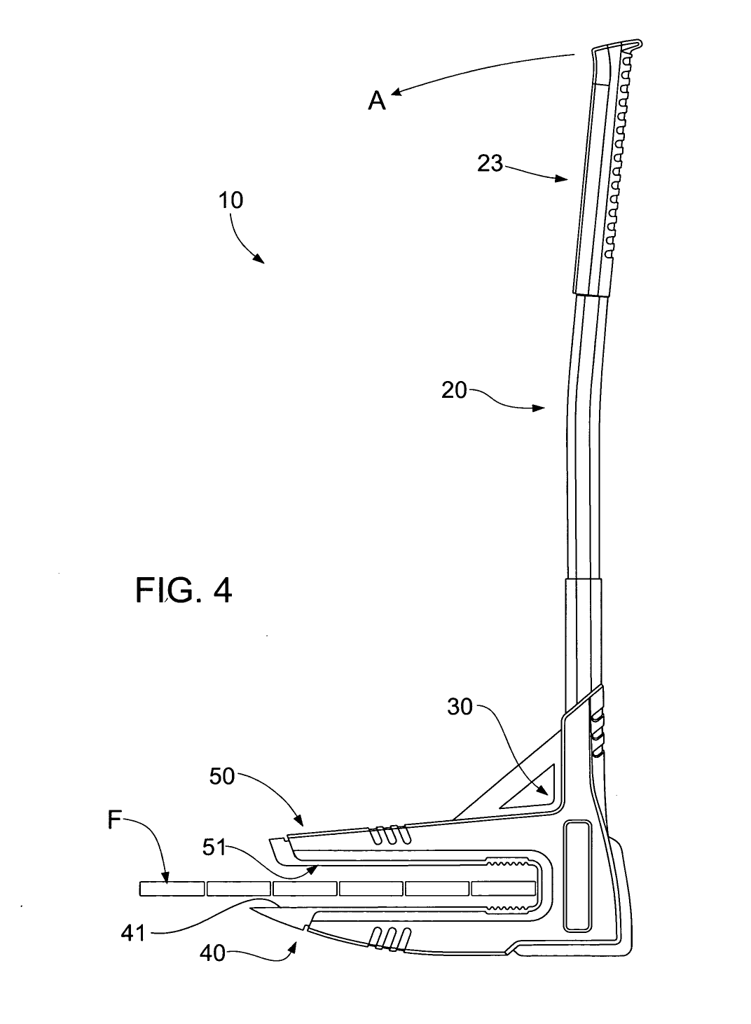

The operation of the tool 10 will now be described in more detail, with reference to FIGS. 4 to 8.

In use, the workman will stand on a portion of the floorboards F to be lifted, with his feet spaced along an axis parallel to the longitudinal axes of the first and second jaw members 40, 50, with one foot forward; and with his hand from the same side at the top of the hand-grip 23, and with the other hand below.

As shown in FIG. 4, the workman engages the tool 10 with the outermost floorboards F to be released from respective joists J. Typically, the tool 10 is located intermediate a pair of the joists J, with the longitudinal axes of the first and second jaw members 40, 50 substantially parallel to the longitudinal axes of the adjacent floor joists J.

On an initial pulling movement, in the direction of arrow A in FIG. 4, the handle 20 tilts forwardly until the longitudinal axis of the hand-grip 23 is substantially perpendicular to the floorboards F, where the distal end 53 of the second jaw member 50 has engaged the upper face of an inner (e.g., the fourth) floorboard F, and the teeth-like projections 42 on the first jaw member 40 have engaged the distal portion of the lower face of the outermost (e.g., first) floorboard F.

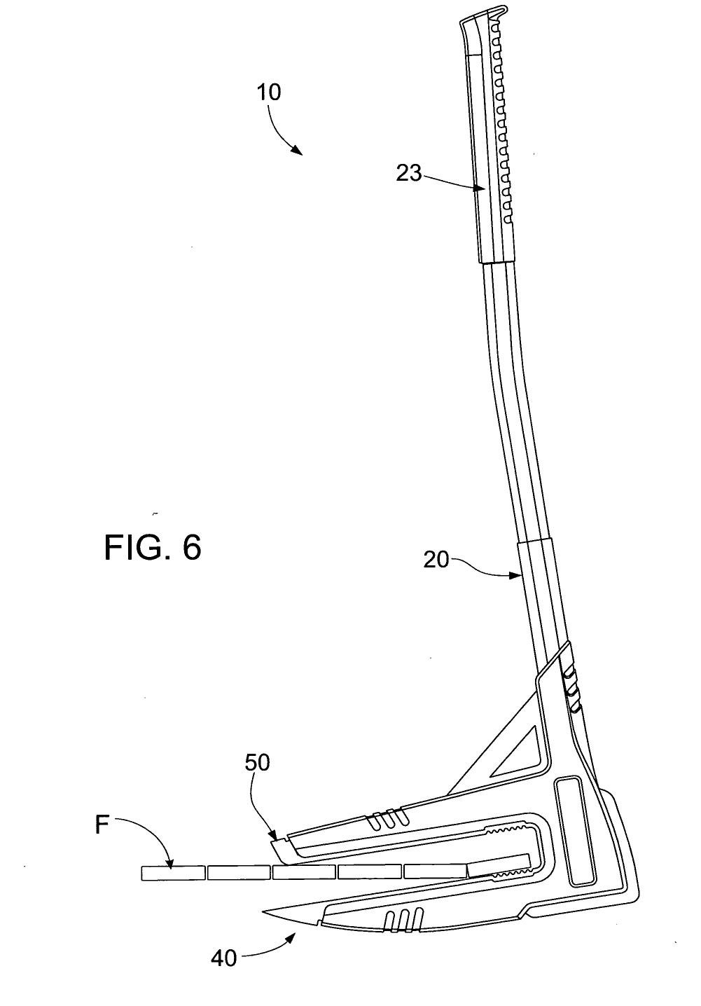

As the workman continues to pull the hand-grip 23 towards himself along the substantially curved path indicated by arrow A in FIG. 4, the second jaw member 50 “pivots” about its line of contact with the ((fourth) floorboard F with which it is engaged; and the inner end of the first jaw member 40 moves upwardly to release the outermost (i.e., first) floorboard F from the adjacent floor joists J. (The fourth floorboard cannot move as it is clamped between the second jaw face 51 and the adjacent floor joists J.) (See FIG. 6.)

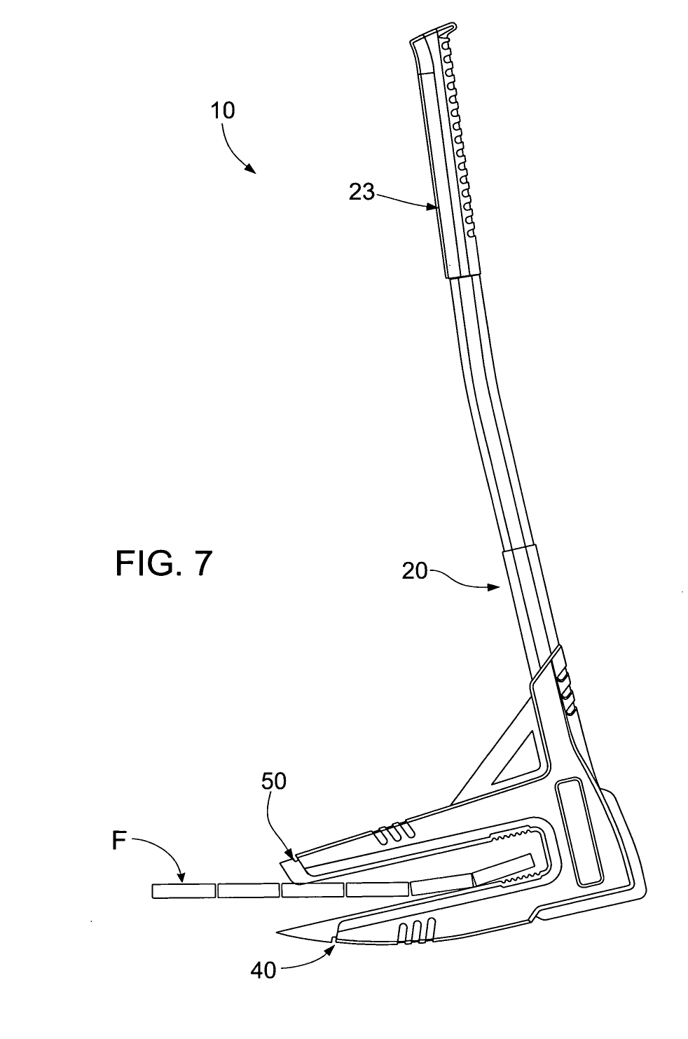

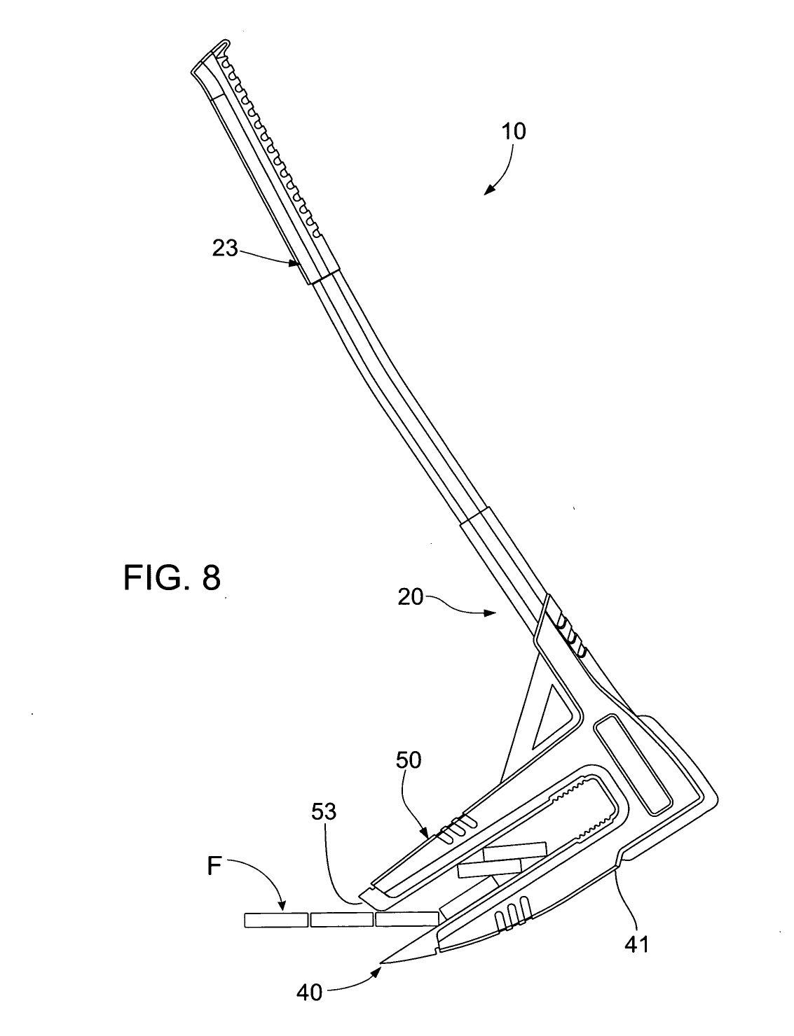

As the workman continues to pull on the hand-grip 23, the next inner (e.g., second) floorboard F is released—see FIG. 7; followed by the subsequent (e.g., third) floorboard F, as illustrated in FIG. 8.

In testing, it has been found that the floorboards F are not only removed, or released, from the floor joists J just to either side of the tool 10, but are typically also removed or released from at least the floor joists to either side of those floor joists. This means, in practice, that where floorboards F are fixed to, e.g., 8-10 parallel floor joists J, the tool 10 may only need to be used at two or three spaced locations to remove or release the floorboards F from all of the floor joists J.

When removed or released, the floorboards F are put to one side; and the operation can then be repeated for the next group of floorboards F.

As the engagement of the second jaw member 50 with an innermost (e.g. the fourth) floorboard F provides the pivot point for the tool 10, the method hereinbefore described cannot be used to remove or release the last one or two floorboards F adjacent a fixed obstruction, e.g., a wall. These floorboards F are removed or released by engaging the pointed tip of the distal end 43 of the first jaw member 40 between the obstruction and the adjacent floorboard F, and raising the hand-grip 23 to “lever” the floorboard F from the floor joists J to which it is fixed.

It will be readily apparent to the skilled addressee that the tool 10 of the present invention enables the floorboards F to be quickly and easily removed or released from the supporting floor joists J; that the leverage provided by the elongate handle 20 reduces the exertion required by the workman; and the “bend” in the handle 20 improves the ergonomic operation of the tool 10 by placing the hand-grip 23 substantially perpendicular to the floorboards F when the latter are first engaged by the first and second jaw members in removal method.

Various changes and modifications may be made to the embodiments described and illustrated without departing from the present invention.

1. A board removal tool for a flooring system comprising:
an elongate handle member;
a first jaw member at, or adjacent, one end of the handle member;
a second jaw member spaced along handle member from the first jaw member;
the first and second jaw members being of substantially equal length and extending substantially laterally from one side of the handle member, in a plane aligned with the longitudinal axis of the handle member, and being provided with opposed first and second jaw faces operable to engage opposed faces of the boards of the flooring system; and
a hand-grip at the other end of the handle member; the longitudinal axis of the hand-grip being inclined relative to the longitudinal axis of the handle member in a direction towards the opposite side of the handle member;
so arranged that the first and second jaw members are operable to remove, or release, the boards from support members or floor joists of the flooring system when the hand-grip is moved along a substantially curved, or arcuate, path in the plane on the one side of the handle member aligned with the first and second jaw members.

2. A board removal tool, as claimed in claim 1, wherein:
the respective lengths of the opposed first and second jaw faces are at least 3 times the width of the boards; and
the first and second jaw members are spaced so that the distance between the opposed first and second jaw faces is in the range of 2 to 6 times of the thickness of the boards.

3. A board removal tool as claimed in claims 2, wherein:
the distance between the opposed first and second jaw faces is in the range of 3 to 4 times the thickness of the boards.

4. A board removal tool, as claimed in claim 1, wherein:
the opposed first and second jaw faces are inwardly convergent and are provided with tough plastics- or rubber-linings or inserts to protect the opposed faces of the boards against damage.

5. A board removal tool as claimed in claim 1, wherein:
The opposed first and second jaw faces are inwardly convergent and are provided, at or adjacent their inner ends, with inwardly-directed “teeth-like” ribs or formations to provide non-slip engagement between the opposed first and second jaw faces and the respective opposed faces of the boards engaged thereby.

6. A board removal tool as claimed in claim 1, wherein:
a substantially L-shaped heel is provided on the handle member, on the other side thereof, at the one end, to enable the tool to be used as a long-handle hammer.

7. A method of removal, or release, of a plurality of boards from a flooring system , employing the board removal tool as claimed in claim 1, comprising the steps of:
locating the opposed first and second jaw faces with the opposed faces of the boards there-between, the first and second jaw members extending substantially transverse to the longitudinal axes of the boards; and
moving the other end of the handle member in a substantially curved, or arcuate, path in a plane on the one side of the handle member, substantially aligned with the first and second jaw members, the handle member being optionally moved by an operator pulling the other end of the handle member, or the hand-grip, towards himself, with two hands.
